(19) United States
(12) Patent Application Publication
(10) Pub. No.: US 2018/0101612 A1
(43) Pub. Date: Apr. 12, 2018

(54) Deriving Farming Operations From GPS Location Data

(71) Applicant: Agrarian Labs, LLC, Avondale, AZ (US)

(72) Inventors: Joseph F. Rosztoczy, Phoenix, AZ (US); Rebecca J. Armenta, Phoenix, AZ (US); Guillaume J. Charmes, Deerfield Beach, FL (US); Brian P. Sorahan, Austin, TX (US); Rex T. Posadas, Round Rock, TX (US); Yan Bai, Wuxi (CN)

(21) Appl. No.: 15/727,909

(22) Filed: Oct. 9, 2017

Related U.S. Application Data
(60) Provisional application No. 62/405,782, filed on Oct. 7, 2016.

(51) Int. Cl. G06F 17/30; G06Q 50/02; G06F 3/14

(52) U.S. Cl. CPC G06F 17/30864; G06F 3/14; G06Q 50/02; G06F 17/30241

(57) ABSTRACT

Systems and methods of the present invention provide for one or more server computers communicatively coupled to a network and configured to: receive and aggregate GPS location data for assets on a farm; determine a window of activity for each asset within a pre-defined work or management zone; determine that a farm activity or operation has occurred; identify and store farm asset turns within received GPS location data; overlay the Identified turns onto existing work or management zones; identify the collection of turns as a virtual work or management zones, and/or or farming activities or operations completed on the farm; extrapolate additional details about each farming activity or operation; and generate a report reflecting this data.

### CROSS-REFERENCE TO RELATED APPLICATION

This application claims the benefit of U.S. Provisional Patent Application No. 62/405,782 filed Oct. 7, 2016, the disclosure of which is hereby incorporated by reference for all purposes.

### FIELD OF THE INVENTION

The present invention generally relates to the field of farming operations and specifically to the field of deriving farming operations from GPS location data.

### SUMMARY OF THE INVENTION

The present invention provides systems and methods comprising: a server computer and a database coupled to a network and one or more farm assets (e.g., equipment, farm workers) each associated in a database with a beacon ID for a beacon transmitting or otherwise emitting a signal with an ID about the asset. In some embodiments, the farm assets include GPS location data (e.g., coordinates, heading), in other embodiments, only the ID is emitted, and an auxiliary device (e.g., a mobile phone running a mobile application) receives the broadcast and generates location data for it.

The server computer may receive and aggregate the GPS location data for each asset, and determine a window of activity for the asset within a pre-defined work or management zone on a farm. If a certain percentage of the aggregated GPS location data is within the zone, the server computer may determine that a farm activity has occurred.

The server computer may also identify turns within windows of received GPS location data, or a buffer holding a predefined number of GPS location data points. If the heading data within the collection of GPS location data indicates an average change in heading greater than a predefined threshold, the server computer may identify and store the GPS location and heading data as a turn by the identified asset. It should be noted that the term that the data identified and stored is not limited to turns. Within this disclosure, any domain specific event (e.g., turning) may be identified and stored in a manner consistent with the identification and storage of turning as disclosed herein.

The server computer may overlay the Identified turns onto existing work or management zones. If a number of GPS data points associated with the turns within the work or management zones is above a threshold amount, the server computer may identify the collection of turns as a virtual work or management zone, which may be a subset of zones within a predefined work or management zone. Each of these work or management zones may identify a farming activity or operation completed on the farm.

Using the data above stored by the server computer, the server computer may extrapolate additional details about each farming activity or operation, and generate a report reflecting this data.

The above features and advantages of the present invention will be better understood from the following detailed description taken in conjunction with the accompanying drawings.

In some disclosed embodiments a server hardware computing device is coupled to network and comprises at least one processor executing specific computer-executable instructions within a memory that, when executed, cause the system to: receive, from a sensor beacon, a plurality of location and bearing data; query a database coupled to the network to identify, in association with the sensor beacon: a geospatial boundary associated with an organization, and an equipment asset; identify, without user input: an operation comprising a cluster of the plurality of location and bearing data received at regular predefined intervals within the geospatial boundary during a time span, at least one working or stationary activity according to a physical distance between a location within the location and bearing data during the time span; automatically generate a graphical user interface (GUI) displaying a report including the operation and the at least one working or stationary activity; and transmit the GUI to a client hardware computing device for display

### BRIEF DESCRIPTION OF THE DRAWINGS

FIG. 1 illustrates a possible system for deriving farming operations from GPS location data.

FIG. 2 illustrates a possible system and method for deriving farming operations from GPS location data, where two assets are in close proximity.

FIG. 3 illustrates a possible system and method for deriving farming operations from GPS location data, where GPS location data is overlaid on a work or management zone to identify a farming activity or operation.

FIG. 4 illustrates a possible system and method for deriving farming operations from GPS location data, where a window of GPS location data identifies a window of activity.

FIG. 5 illustrates a possible system and method for deriving farming operations from GPS location data, where a collection of GPS location data indicates a turn according to a change in heading.

FIG. 6 illustrates a possible system and method for deriving farming operations from GPS location data, where a heading is adjusted to reflect a farming operation.

FIG. 7 illustrates a flow chart illustrating a possible method for deriving farming operations from GPS location data.

FIG. 8 illustrates a possible system and method for deriving farming operations from GPS location data, where a collection of turns is used to identify a farming activity or operation.

FIG. 9 illustrates a possible system and method for deriving farming operations from GPS location data, where multiple virtual zones are output.

FIG. 10 illustrates a flow chart illustrating a possible method for deriving farming operations from GPS location data.

FIG. 11 illustrates a flow chart illustrating a possible method for deriving farming operations from GPS location data.

FIG. 12 illustrates a flow chart illustrating a possible method for deriving farming operations from GPS location data.

FIG. 13 illustrates a flow chart illustrating a possible method for deriving farming operations from GPS location data.

FIG. 14 illustrates a flow chart illustrating a possible method for deriving farming operations from GPS location data.

FIG. 15 illustrates a non-limiting example of a GUI used in deriving farming operations from GPS location data.

FIG. 16 illustrates a non-limiting example of a GUI used in deriving farming operations from GPS location data.

FIG. 17 illustrates a non-limiting example of a GUI used in deriving farming operations from GPS location data.

FIG. 18 illustrates a non-limiting example of a GUI used in deriving farming operations from GPS location data.

FIG. 19 illustrates a non-limiting example of a GUI used in deriving farming operations from GPS location data.

FIG. 20 illustrates a non-limiting example of a GUI used in deriving farming operations from GPS location data.

FIG. 21 illustrates a flow chart illustrating a possible method for deriving farming operations from GPS location data.

FIG. 22 illustrates a flow chart illustrating a possible method for deriving farming operations from GPS location data.

### DETAILED DESCRIPTION

The present invention will now be discussed in detail with regard to the attached drawing figures that were briefly described above. In the following description, numerous specific details are set forth illustrating the Applicant's best mode for practicing the invention and enabling one of ordinary skill in the art to make and use the invention. It will be obvious, however, to one skilled in the art that the present invention may be practiced without many of these specific details. In other instances, well-known machines, structures, and method steps have not been described in particular detail in order to avoid unnecessarily obscuring the present invention. Unless otherwise indicated, like parts and method steps are referred to with like reference numerals.

Farming today requires long and labor-intensive work days. Because of the time-intensive nature of farming, the additional time needed for record keeping and general administration may detract from time that could otherwise be used to improve the productivity of the farm activities or operations themselves. The disclosed embodiments, therefore, eliminate much of the time and effort required to keep on top of such farm-related bookkeeping and administration by automatically tracking the activities performed by specific pieces of equipment and the farm workers who may operate the equipment. To accomplish this, the disclosed embodiments include a process to identify and record near-real-time farm activities within a farming operation accomplished by farm workers or other personnel operating equipment within various work or management zones within the perimeters of the farm.

The disclosed embodiments may include a system configured to execute the method steps for the process described above. The architecture of this system may include at least one server 110 coupled to a network 100. The server 110 may be any combination of one or more computing devices including one or more server computers (i.e., a server cluster), one or more client computers, one or more mobile devices, etc., and the network 100 may include any known local or wide area networks, such as the Internet.

Server 110 may include one or more processors executing any combination of computer logic, possibly within one or more software modules, stored in, and performed by, instructions within a memory. The memory may be coupled to server 110, possibly as on-board memory (e.g., RAM or hard drive), or possibly communicatively coupled to server 110 through network 100.

Server 110 may also be coupled to data storage 130, possibly as part of server 110, or through network 100. Data storage 130 may include one or more databases. The data within data storage 130 may include a relational (e.g., MySQL) or other (e.g., NoSQL) database, and may further include a series of data tables, data records, data fields or columns within data records.

The data within data storage 130 may include, as non-limiting examples: data for supplementing the instructions executed by the processor(s) (e.g., one or more rules or thresholds for determining if a method step within the instructions should be executed), data identifying the assets used in the farming activities or operations (e.g., a beacon attached to, and identifying GPS locations for a tractor, a cell phone used by an operator of the equipment, etc.), coordinate or other mapping data defining the perimeter of the farm and one or more work or management zones within the farm; GPS data transmitted by a beacon or cell phone app and received and stored by server 110 within data storage 130 during farming activities or operations; etc. It should be noted that the use of the phrase “GPS location data” or any additional similar phrases is not limiting. Specifically, GPS location data, as used throughout this disclosure, may generalize to other sensor data, such as an accelerometer, and thus may be a subcomponent and therefore not limiting.

The database may associate each asset used in a farming activity or operation with a unique identifier (ID). Assets used in a farming activities or operation may include farm equipment such as tractors, spreaders, planters, combines, trucks, etc., and the personnel that operate the farm equipment. For example, a data record for a tractor, a corn planter, and one of the workers/operators may include the following data fields within a farm asset data table:

| asset id | name |
|---|---|
| 1 | Tractor 1 |
| 2 | Corn Planter |
| 3 | John Doe |
| . . . | . . . |

Each asset may further be associated in the database with a unique ID. In some embodiments, these may be wireless devices that emits a signal with the unique ID. In some embodiments, the signal may be from a GPS-capable beacon that emits and/or identifies a signal (also referred to herein as a heartbeat). This signal may be a transmission identifying the farming asset to which the beacon is attached. For example, a data record for the beacons associated with various assets may include the following data fields within a beacon data table:

| beacon id | asset id |
|---|---|
| 1 | 1 |
| 2 | 2 |
| 3 | 3 |
| . . . | . . . |

The transmission may also include GPS location data (e.g., GPS coordinates and heading) for the asset at a given time on a given date. Similarly, any combination of hardware and software (e.g., a mobile app on a mobile device, such as a smart phone, tablet, or laptop) may also include such a beacon transmitting the GPS location data for the mobile device. Each of the various personnel working on the farm may be associated with a specific device, as seen above, so that the GPS location of the device provides a location of the farm worker at a given time on a given date. For example, a data record for the GPS location data associated with beacons and/or assets may include the following data fields within a GPS location data table:

| id | b id | lat | long | heading | time-date |
|---|---|---|---|---|---|
| 1 | 1 | 112.03 | 60.03 | 90 | 12:00:00 1/1/16 |
| 2 | 2 | 105 | 75 | 87 | 12:00:00 1/1/16 |
| 3 | 3 | 110 | 65 | | 12:00:00 1/1/16 |
| . . . | . . . | . . . | . . . | . . . | . . . |

Server 110 may receive each of the transmissions of GPS location data from the beacons, and store the GPS data within a database coupled to the server. For example, as seen above, a beacon, with a device emitter ID of 1, may be attached to an asset, such as Tractor 1. The beacon may include wireless sensors, and may be configured to emit a heartbeat broadcasting the device emitter ID, and also identifying the GPS location data (e.g., latitude, longitude, heading) of the emitting beacon device, as well as the time and date the GPS data was transmitted. In some embodiments, instructions loaded into the memory of the server 110 or stored in the database may include parameters defining a regular interval for which the GPS data should be transmitted (e.g., every 2-3 seconds).

Server 110 may receive the GPS location data identifying one or more GPS locations for the asset (e.g., locations for a tractor and/or tractor operator). For each GPS location data received, server 110 may access a database interface, and insert the GPS location data into the database. Using the tractor example above, server 110 may insert one or more data records, each including: a unique identifier for the GPS location data record; a unique beacon identifier for the device emitter associated with Tractor 1; a time at which the GPS location data signal was transmitted; and the coordinates and heading associated with the transmission during that time.

Server 110 may aggregate the GPS data for each of the assets, and may execute any combination of software modules running server processes to analyze the received and stored GPS location data. For example, server 110 may select all GPS data associated with a unique identifier for the tractor and/or the mobile device described above. For each GPS location data associated with the unique asset id, the server may compare the GPS location data with a GPS location data containing the same unique asset ID and associated with an earlier timestamp. If the server process determines that the GPS location data associated with the unique asset id has changed since the earlier timestamp, the server process may determine that the asset has changed location during that time period.

The server processes may also analyze the GPS location data to determine when and where farming activities or operations were performed by a particular asset, and which work or management zone areas the activities or operations applied to. These work or management zones may include a pre-defined or virtually constructed data structure representing physical space within which work is happening on the farm. The server processes may define the farm according to an area represented by GPS locations, such as a series of coordinates, which include all area within a perimeter. This area may be subdivided into work or management zones, defined by a set of GPS data or coordinates within the perimeter of the farm. The server processes may identify farm activities or operations by overlaying the GPS location data from various farm assets over the area that defines the farm or the work or management zones within the farm.

An example farm may include work or management zones such as two farm fields, a parking lot, a farm asset storage and maintenance area, a farm house, and a road dividing the two farm fields. The coordinates for the perimeter of the farm, as well as the coordinates for each of the zones within the farm, may be defined within the instructions in memory, or within data stored in the database. These instructions or other stored parameters may identify the farm fields as being associated with business activities, and the house, parking lot/maintenance area and road as not being associated with business activities.

The server processes may include algorithms to identify assets that are paired or otherwise coupled during a farm activity or operation. The software instructions or data stored in the database may define a proximity threshold between two assets, and if the GPS location data for farm equipment and the GPS location for an operator of the farm equipment are determined to be within the defined proximity, the farm equipment and the operator of the farm equipment may be paired so that the server processes associate both with a particular farm activity or operation, described below. In some embodiments, server 110, or any available beacons may identify all sensors within range of other beacons, but may generate an adaptive window of devices to filter out ‘noise,’ (e.g., transmitted data not relevant to a farm activity or operation) such as other auxiliary equipment unassociated with the activity or operation.

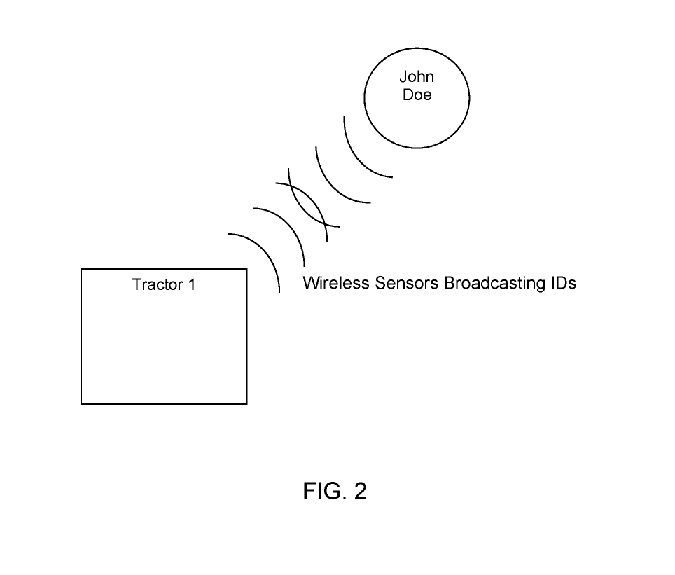

As seen in FIG. 2, which demonstrates the tractor example above, the beacon for Tractor 1 and the mobile device for the operator, John Doe, may broadcast their respective device emitter ID and GPS location data. The server processes may receive the transmitted data, and for each identified device emitter, may start a server process to identify the associated assets. The server processes (or possibly the app on John Doe's cell phone) may determine the proximity of John Doe's cell phone to Tractor 1. If this proximity is within the defined threshold proximity for a certain period of time (i.e., during multiple GPS location transmissions), the server processes may pair/couple John and Tractor 1, and associate them with a specific identified farm activity or operation. The server processes may therefore determine that John Doe was operating Tractor 1 during this farm activity or operation.

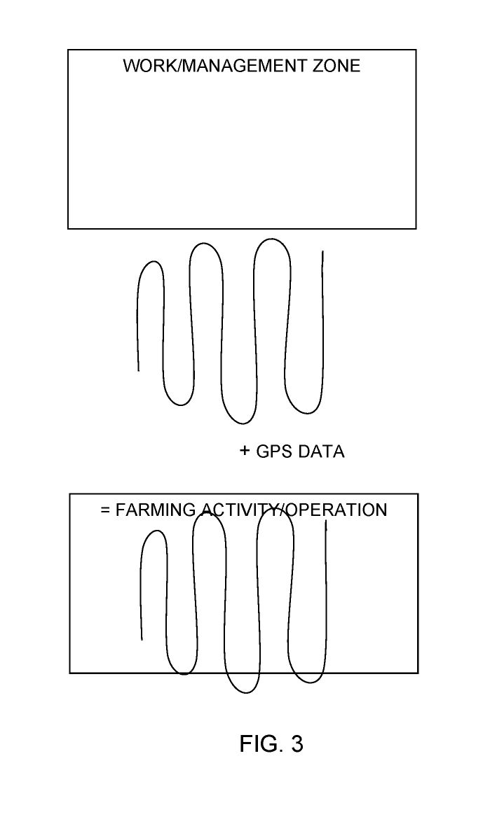

Referring now to FIG. 3, the work or management zone may represent the physical space within which work is happening on a farm. As described above, the work or management zone may include a pre-defined data structure according to the coordinate or other data stored in the database. The work or management zone may also be virtually constructed as described below. Further, as described above, the GPS data may include an agent-based location history, where the agent may include any asset such as farming machinery, the personnel operating the machinery, or any other assets that may accomplish work on the farm. As seen in FIG. 3, the server processes may combine or overlay this data to identify a farming activity or operation, a data structure created when a threshold density of GPS data exists within a management zone within the perimeter of the defined farm.

The server processes may identify farm activity or operation “windows” by calculating locations, based on GPS location data, being inside or outside of a work or management zone over a rolling window of heartbeats. The number of heartbeats that make up an activity may be defined according to a window size and a specific percentage defined within software instructions for the server processes or stored in data storage.

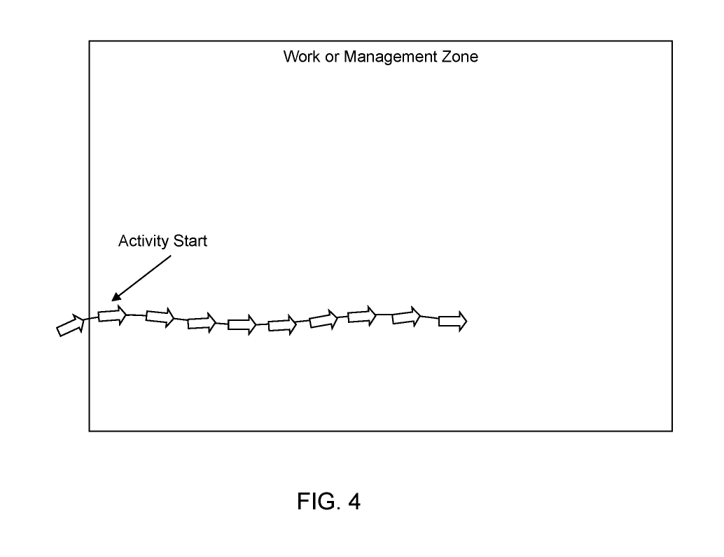

For example, FIG. 4 represents an intuitive way of visually defining a farm activity or operation. In FIG. 4, a work or management zone, and 10 different heartbeats containing GPS location information have been transmitted to server 110, 9 of which are within the defined work or management zone. The instructions or stored data may define a window size of 10 heartbeats/GPS locations, and a percentage of 90%. In FIG. 4, 9 of the 10 received heartbeats, or 90% are within the defined management zone over the course 10 rolling heartbeats. Because the threshold amount of GPS locations is the proper percentage, the collection within the window may be considered a window for a farming activity or operation.

The server processes may calculate a farming activity or operation start based on the number of heartbeats within the window that fall inside a given work or management zone. The activity start time is calculated according to a retroactive analysis of the timestamp associated with the GPS location data calculated by multiplying the window size by the percentage threshold. In the example seen in FIG. 4 and discussed above, the number of heartbeats in the window is defined as 10, and the threshold percentage is defined as 90%. The server processes would therefore backtrack 9 heartbeats (10*0.9), and analyze the received GPS location data to identify the associated timestamp to determine the start time of the window for the farming activity or operation.

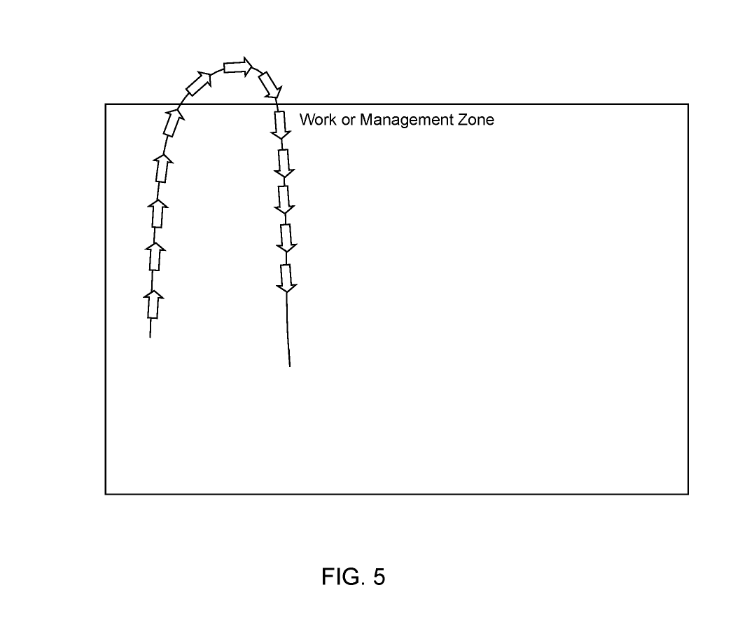

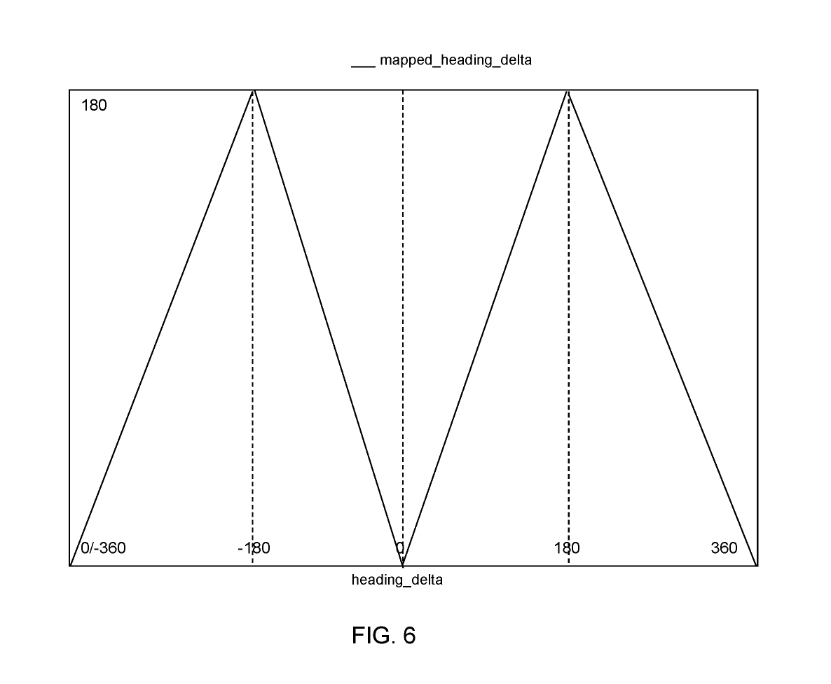

The server processes may also analyze the GPS location data within a collection window to determine if the farm equipment associated with the GPS location beacon has executed a turn within a defined or virtually constructed work or management zone. As seen in FIG. 5, the server processes may identify a turn based on an average change in heading according to the heading data transmitted by the beacon for each heartbeat. The heading values transmitted as part of the GPS location data may be measured as offsets in degrees from magnetic north, may include a range of heading values of (0, 360), and therefore the heading deltas may have a range of (−360, 360). However, if, for example, a tractor changes headings from 0° to 359°, a heading change of 1° would make more sense in the farming activity or operation context than a heading change of 359°. The server processes may therefore execute a piecewise function used to map the heading deltas to values that make sense in the context. FIG. 6 demonstrates such a piecewise function. Thus, as seen in FIG. 5, the server processes may therefore compute a turn from the average change in heading for a window of a certain number of heartbeats where a change in heading is the difference between one reading and the next.

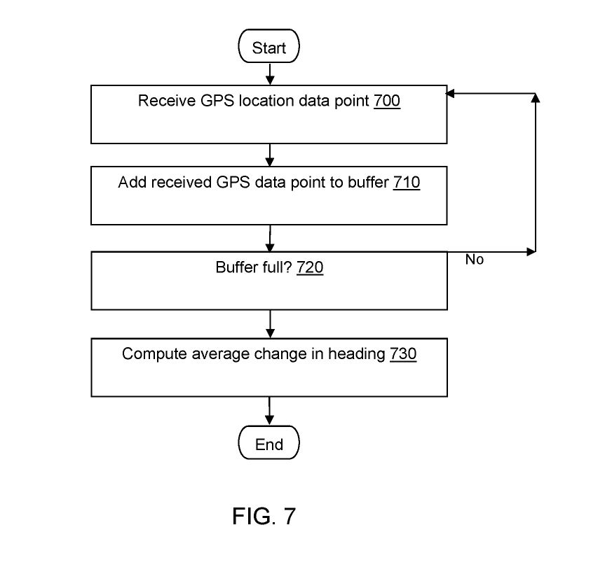

In some embodiments, the server processes may define a buffer used for the window to identify a turn referenced above. The software instructions within the memory, or stored in data storage, may define the buffer as a specific number of GPS location data points, and may further define a sampling frequency for the data and a degree threshold, over which a change in heading will be considered a turn. As seen in FIG. 7, the server processes may receive a GPS location data point (Step 700), and if it is the first received data point, may add the GPS location data to the buffer (Step 710). The server processes may receive each subsequent GPS location data point, and determine if the number of received data points fills the buffer (Step 720). If not, the data point is added to the buffer and the server processes await receipt of the next GPS location data point.

If the received data point fills the buffer, the server processes compute the average change in heading over the total heading change determined from the GPS location data points within the buffer (Step 730). The server processes may compute the average change in heading by repeating the following process for each GPS location data point in the buffer: if the data point is the first in the buffer, the server processes may identify the heading data within the GPS location data for that data point, and analyze the subsequent data point. Otherwise, the server processes may identify the heading data within the GPS location data, and compare the heading data with the previous heading data in the buffer to compute the change in heading between the current and previous heading data. The server processes may then add the change in heading to a running total of heading changes, and when the last data point in the buffer is reached, divide the total change by the buffer size.

For example, the instructions or database may define a window buffer of 10, a sampling frequency of 2 seconds, and a degree threshold of 30. The server processes may receive GPS location data points including heading changes of 20°, 30°, 40°, 50°, 60°, 60°, 50°, 40°, 30°, and 20° for each of the respective data points. The server processes may total the heading changes, resulting in a total of 400. The server processes may then divide the total by the number of data points in the buffer (10), resulting in an average heading change of 40°. Because 40 is greater than the defined degree threshold of 30, the server processes may determine that a turn has occurred, and may store the turn details data within the database.

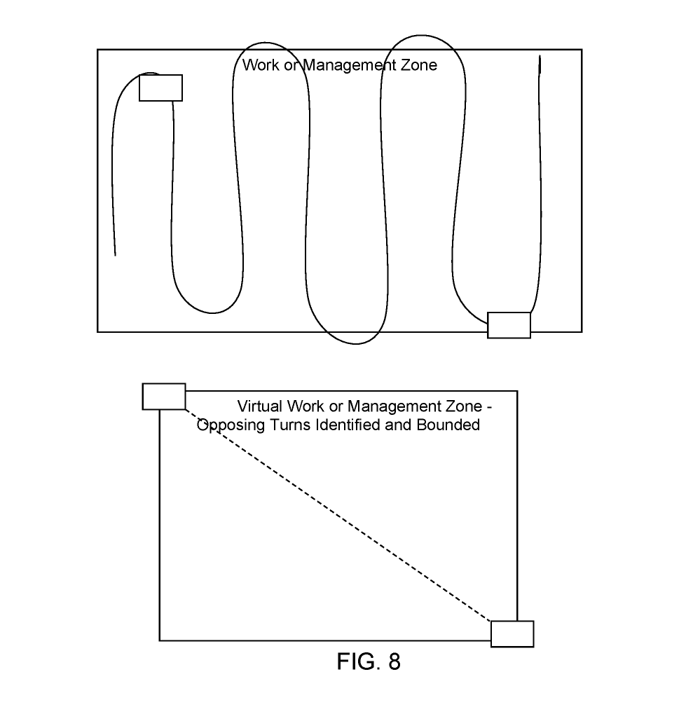

The server processes may use the GPS location data, as well as the stored identified turn detail data, to identify virtual work or management zones. For example, a virtual work or management zone may include a previously unidentified work or management zone. In addition to the predefined management zones described above, the server processes may generate the virtual work or management zones without user input. A virtual work or management zone may also include a subdivision of a predefined existing work or management zone, such as a field divided in such a way as to grow different crops (e.g., corn on half, potatoes on half), which would in turn require different farming operations (e.g., different pesticide distribution) to be performed on them at different times. In one embodiment seen in FIG. 8, the server processes may identify a virtual work or management zone by identifying opposing turns and bounding identified opposing turns.

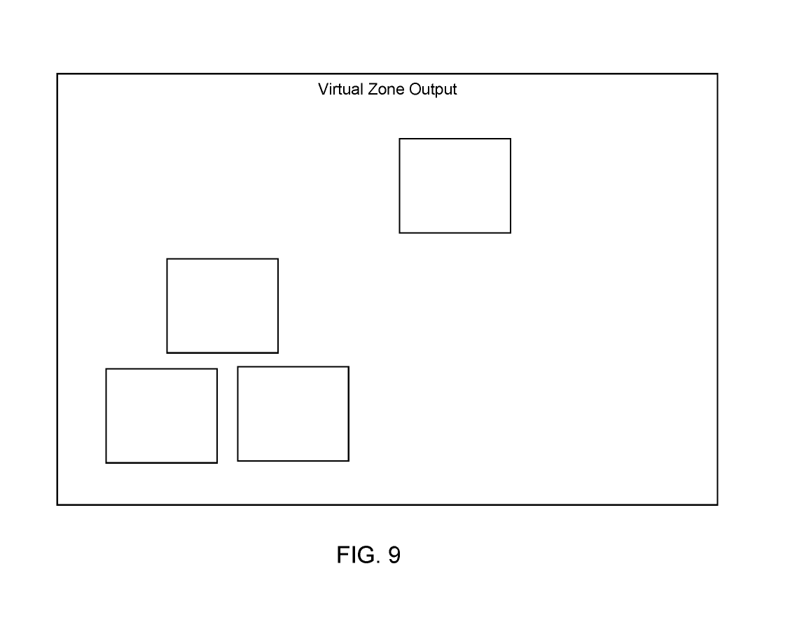

To accomplish this, the server processes may execute one or more overlay software worker modules. The overlay worker may aggregate all identified turns stored in data storage and associated with the specific unique beacon ID and its associated farm equipment, and generate a boundary, or convex hull, encompassing the location points associated with all included turn data. The overlay worker then analyzes existing work or management zone data to determine if the boundary intersects an existing work or management zone. If so, the overlay worker groups all intersected zones together and generates a second boundary or convex hull around the boundaries of all intersected work or management zones. The overlay worker then identifies a virtual management zone as the generated boundary or convex hull, and the overlay of the GPS location and turn data within the generated boundary, as seen in FIG. 9.

Utilizing the generated virtual management zone, a pre-defined work or management zone, and the turns and/or other GPS location data associated with the work or management zones, the server processes may define the details of a farming activity or operation. For example, the server processes may identify a start of a farming activity or operation by executing a backtracking algorithm in response to an identification of a first turn that overlaps a work or management zone. The backtracking algorithm may retroactively trace a series of heartbeats to the first GPS location data point within identified same management zone. The backtracking algorithm, or other server processes, may identify the timestamp data received from this GPS location data point to determine the start time for the operation.

In some embodiments, the server processes may include more specific parameters. For example, the server processes may identify the start of a farming activity or operation by identifying two turns where 80% of the GPS location data points associated with the two turns exist within the same work or management zone. The server processes may identify the end of the farming activity or operation trigger by identifying 80% of the GPS location data points within the last two turns as being outside of the work or management zone.

The server processes may also utilize the farming activity or operation, work or management zones, window, turning, GPS location, and/or farm asset data to identify non-operation activity. For example, the server processes may identify a collection of GPS location data associated with a beacon and/or farm equipment within an identified work or management zone. However, using the algorithms for identifying a window of activity, the server processes may eliminate false positives, such as a farm vehicle traversing through a zone for transport during the course of the day. Operations and activity may therefore be distinguished as well, for example, by splitting the GPS location data into subsections of an operation by offsets, such as end of day. The server processes may therefore use these distinctions to assign various activities to groupings of GPS location data, such as farming operation activities, transport activities, stationary activities, etc.

Using any of the data associated with the received or stored data disclosed above, the server processes may identify a more specific goal or purpose behind, or any of the details associated with a farming activity or operation. For example, by analyzing the received and stored data associated with a specific farming activity or operation, the server processes may generate a report identifying a name for the activity or operation, the purpose of the operation (e.g., if using a spreader, probably throwing fertilizer), the work or management zone or a subsection affected by the activity or operation, a number of acres affected by the activity or operation, the farm assets or equipment used for the activity or operation, the first name and/or last name of the operator of the equipment, the average speed of the equipment, whether or not the equipment is self-propelled, the distance traveled by the equipment, a start or end time for the operation, the associated time zone for the start and/or end time, the date the activity or operation was completed, the company associated with the operation, historic company patterns, etc.

The server processes may further be configured to: perform anomaly detection on missing location data and assets (e.g., missed heartbeats, equipment, etc.) to supplement active working time of the activity/operation; assign algorithm names, versioning, and data structure lifecycle to allow for user editing of computed operations, or rewriting of operations with updated algorithms; and/or backtrack location points to identify start and end time, as disclosed above.

Many farming operations require extensive record keeping. However, many farms do not have the technical savvy to create an electronic recordkeeping system. Many farms, therefore, do not currently have a digital representation of the data needed to run a farm and track the farm's effectiveness, and by extension, have no access to automated data regarding when farming operations (e.g., planting a field) are needed or complete. If such data is available at all, it is often input manually from a farmer or other administrator of the farming organization using some sort of manual data entry program. Even then, the farmer or administrator may have too many other responsibilities to have time to enter the data. So even if data is input and produced at all, it is often not valuable. For example, many crops may need to be planted, sprayed, etc. within a specific and limited window. The process may be so hectic during the planting process that there is no opportunity to input the necessary data to record the planting, so the data is not later available to review.

The disclosed embodiments take advantage of the heartbeat data processes described above to automatically generate, without user input, task records, including completed tasks, resources used to complete the tasks, etc. This generated data may provide a farming organization quick access to relevant task data. Using this task data, the farming organization may make better business efficiency decisions, such as determining which equipment and operators to use in future operations. In short, the disclosed system may receive heartbeat data from the equipment and operators, process the data, and generate reporting data to users.

To accomplish this, the disclosed embodiments include one or more software modules configured to automatically receive and process sensor data feeds of heartbeat data from the sensors attached to or otherwise associated with equipment and/or operators, as described above. One or more farming operation generation engine systems, subsystems, and/or software modules (also referred to herein as a recordkeeping system, data aggregation system, algorithm and data pipeline, etc.) may find, identify, and produce farming operations and associated context data. This system may then analyze, generate, store, aggregate, and/or display operation, activity, task, or context data relating to the associated equipment and/or operators on a day-to-day basis, as well as providing information on who may be involved in farming operations such as planting, harvesting, spraying chemicals for specific crops, etc.

This recordkeeping system may then deliver a set of analytics and visualizations to the farming organization according to the aggregated data. These analytics may assist the farming operation in determining, for example, acreage covered by each operator (e.g., best performers), any downtime, the cause of the downtime, etc. The farming operation may then make better decisions to better manage the organization (e.g., which operators are the most efficient, which need more training, which equipment is operating most efficiently, which should be replaced, etc.).

The disclosed embodiments may apply the aggregated data to assist larger farming organizations including farms that are distributed geospatially, so that the farming organization may view data in real time to identify equipment and operators, and their current activities, even in highly distributed farming operations. The stored operation data may further be separated and isolated as context data, and may be integrated with third party data and/or software to determine, for example, an equipment's chemical consumption or use, seed distribution, etc., and map the received data to an identified operation. The disclosed system may then provide reporting data to the farming operation.

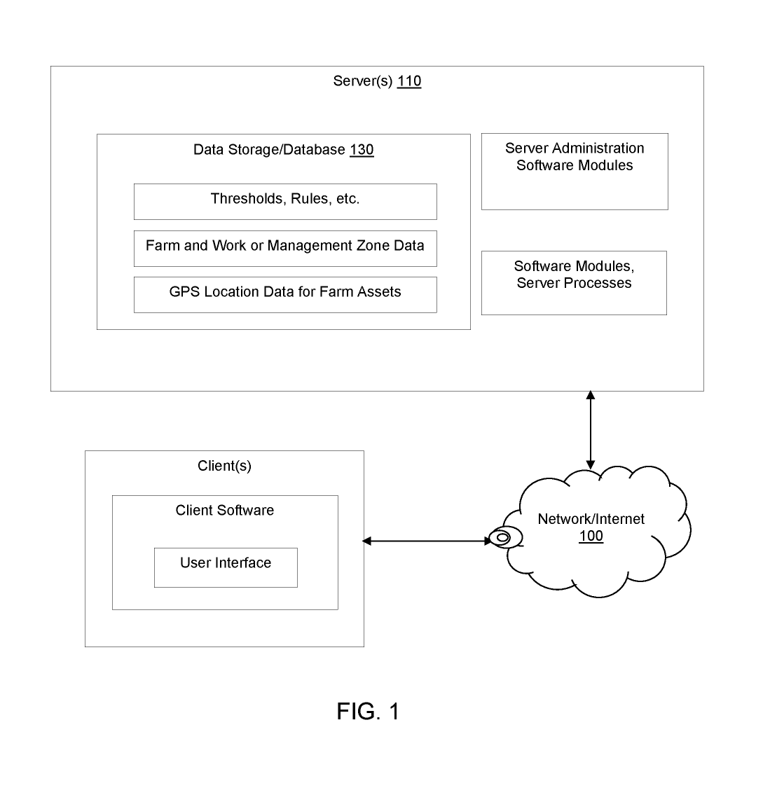

Returning to FIG. 1, the disclosed system may include any combination of hardware server computing device(s) 110, client hardware computing devices, and/or data storage 130, communicatively coupled to a network 100. The server hardware computing devices may include any combination of server software modules, including server administration software modules, server processes, etc. Likewise, the client hardware computing devices may include one or more client software modules. In some embodiments, the server software modules may generate one or more graphical user interfaces (GUI), which may then be transmitted to, and displayed on, the client hardware computing device(s). The GUI may receive user input, possibly through interaction with one or more GUI controls displayed on the GUI, and transmit the received user input back to the server hardware computing device 110 for processing and/or storage.

The server hardware computing device 110 and client hardware computing device may include one or more processors executing computer-executable instructions within a memory communicatively coupled with the server hardware computing device or client hardware computing device. The computer-executable instructions, when executed, may cause the server hardware computing device 110, and/or the client hardware computing device to execute the method steps within the processes described herein. Because of the commonalities of processors, memory, software modules, and instructions, and in the interest of simplicity, this disclosure may refer to any of these hardware and software environment elements as server 110. However, it should be understood that the method steps in the disclosed processes may be executed by any combination of server hardware computing device 110 and the client hardware computing device.

Data storage 130 may include any electronic storage capable of storing data for a period of time. As non-limiting examples seen in FIG. 1, data storage 130 may store any farm, work, or management zone data as described herein, and/or may include any of the heartbeat data, operator data, equipment data, task data, activity data, operation data, analytics data, or any other data described herein or necessary for the described embodiments. In some embodiments, data storage 130 may include software logic, including any software rules and/or necessary definitions or defined thresholds, needed to fulfill the embodiments described herein. However, these embodiments should be understood to be non-limiting. Software logic may be stored in any combination of data storage 130 and/or software instructions executed by server 110.

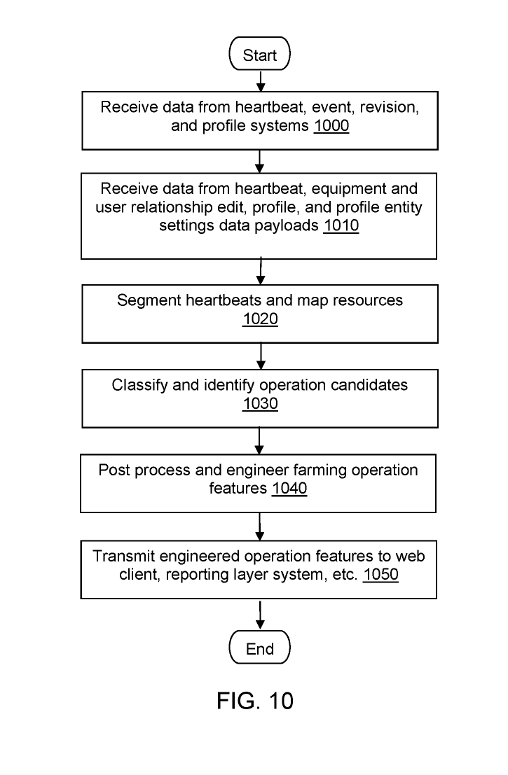

FIG. 10 is a flow process representing a high-level overview of the disclosed system. In step 1000, server 110 may receive input data from one or more heartbeat, historical user event, revision, revision propagation, and/or profile systems. Profiles and revisions may include profiles for any type of farm asset, including equipment, operators, fields, etc. In some embodiments, users of the disclosed system may review the generated heartbeats, historical events, and/or profile data, and edit them to ensure accurate data.

Server 110 may then analyze and manage the received data. To ensure that the data is coming from intended sources, the software rules may intentionally define one or more management boundaries, accessible to each of the disclosed systems or data payloads, through which analysis and management of the incoming event data may occur. For example, the disclosed systems may explicitly grant access to the disclosed profile system.

In step 1010 of FIG. 10, server 110 may receive data from one or more data payloads. As non-limiting examples, the disclosed embodiments may receive data payloads including data from one or more processed heartbeats, equipment and user relationship edits, profile entity settings effective dates, and/or profile CRUD (Create, Read, Update, and Delete) data payloads, which may be managed within the receiving system. The data may be received through the management boundaries described above, through which management of the incoming event data may occur. For example, the disclosed systems may explicitly grant access to one or more profile CRUD data payloads.

In step 1020, server 110 may execute one or more middleware data processing steps wherein a middleware is configured to segment received heartbeats and to map resources. In some embodiments, offline heartbeat event triggers may be included.

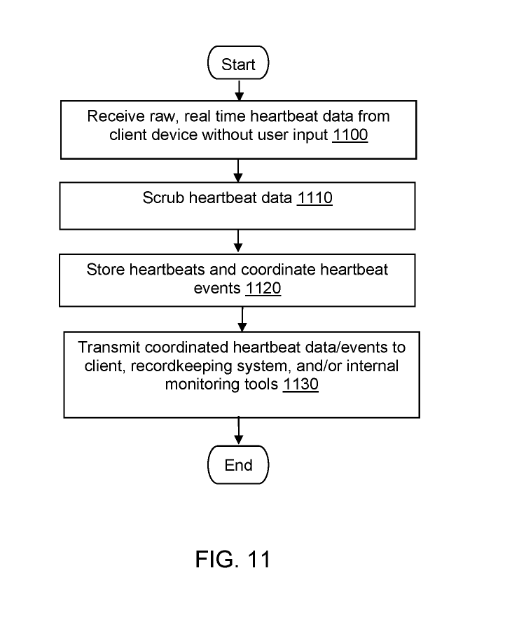

FIG. 11 is a flow process including a more detailed example process for receiving heartbeat data, as represented in steps 1000-1020 of FIG. 10. As noted above, a client software application (e.g., an app running on an equipment operator's mobile device) and/or server 110 may include a pairing algorithm, which pairs each operator with a beacon. The beacon may include a “black box” sensor which may generate and broadcast/transmit signals including sensor and/or heartbeat data (e.g., GPS signals). The beacon may be physically attached to, or otherwise associated with, the equipment and/or one or more associated implements in use by the operator (e.g., a tractor). Data storage 130 may store the beacon, equipment/implement, operator, operator's client software, and/or any other farm assets, in association.

In step 1100 of FIG. 11, the beacon and/or client software may automatically transmit, without user input, raw, real time heartbeat data, which may be received by server 110. The raw, real time heartbeat data may be received from the client software, and/or as a data payload, through the management boundaries described above, through which management of the incoming heartbeat data may occur.

In step 1110, server 110 may execute one or more middleware data processing steps to scrub, or otherwise clean out the heartbeat data. In other words, the middleware on server 110 may determine that the incoming sensor data is corrupt or otherwise unusable, and remove it. In step 1120, server 110 may execute one or more middleware data processing steps to store heartbeats within data storage 130, and coordinate heartbeat events.

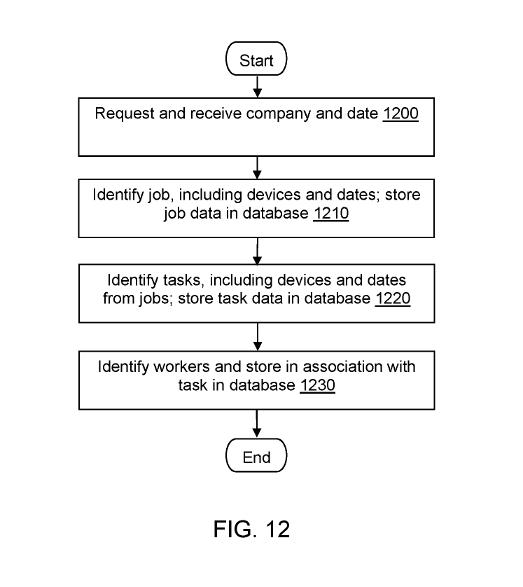

FIG. 12 is a flow diagram demonstrating a non-limiting example of the process of storing heartbeats and coordinating events, as described above in association with step 1120 of FIG. 11. In step 1200, server 110 may request and/or receive any combination and/or range of all heartbeats associated with one or more companies, devices, and/or dates/times. For example, server 110 may request and/or receive all raw heartbeat data for a specific company on a specific date.

In step 1210, server may utilize the requested and received data to identify and define one or more jobs, which may include any combination or range of devices and/or dates. Server 110 may then store the job data within data storage 130.

In step 1220, server 110 may analyze, identify, define, and/or generate one or more tasks, including devices and dates, from the job data. Server 110 may then store the task data in data storage 130.

In step 1230, server may analyze, identify, define, and/or generate one or more workers associated with each of the tasks. Server 110 may then store the worker data in data storage. The company, date, job, task, and worker data may be utilized in the algorithms disclosed herein, in order to generate the analytics data helping farming organizations improve efficiencies.

Returning now to FIG. 11, in step 1130, server 110 may transmit the processed heartbeat and/or coordinated event data to the one or more output target hardware or software explicitly targeted to receive system output. As non-limiting examples, these targets may include a GUI for display on a client hardware computing device, the disclosed farming operation generation and recordkeeping system, or one or more internal monitoring tools (e.g., bots) used to keep the disclosed system and data accurate and reliable. In some embodiments, this data may be transmitted outside the barrier described above, in order to provide all data needed to the consuming applications.

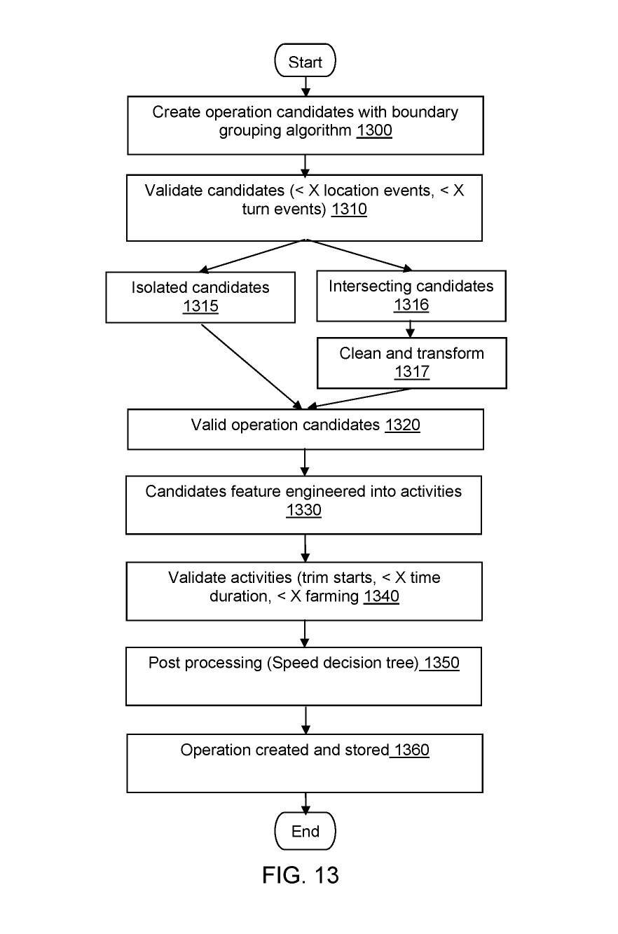

Returning now to FIG. 10, in step 1030, server 110 may classify and identify farming operations candidates, and in step 1040, perform post processing and engineer farming operation features. FIG. 13 is a flow diagram demonstrating the method steps for a more detailed process for identifying and classifying farming operation candidates, and for feature engineering farming operations.

In step 1300, server 110 may create candidates using a boundary grouping algorithm. Server 110 may execute this boundary grouping algorithm by identifying all stored devices and geospatial zones, and scanning through and analyzing the details of each of the identified geospatial zones to search for and identify clusters of heartbeats (e.g., GPS points) from each of the stored and identified devices.

The algorithm may utilize a set of moving parameters. These parameters may include identified clusters of heartbeats, or heartbeats from a single device, clusters that appear to be intentional behavior in a specific geospatial zone (e.g., an identified field), etc. Server 110 may then group all heartbeats geospatially by management zones. Each management zone group is referred to as a “candidate” operation.

It should be noted that the data analyzed in the boundary grouping algorithm is not entered by a user. Instead, server 110 stores and identifies geo/geospatial boundaries, according to the user's current location determined from the transmitted heartbeat data, and correlates that location with the boundaries of the stored geospatial boundaries for each field or other geospatial management zone.

In step 1310 of FIG. 13, server 110 may validate, or “clean” candidate farming operations to determine whether there are any outliers in the data. In other words, the system may refine a pool of potential farming operation candidates to determine whether the raw data meets one or more minimum thresholds (possibly defined and stored in data storage 130) required to qualify as a farming operation candidate. As non-limiting examples, server 110 may validate candidates by invalidating any candidates with less than 400 heartbeats (i.e., with less than X number of location events, as defined above), and/or by invalidating candidates with less than 4 identified turn events (i.e., less than X number of turn events, as defined above).

Step 1320 of FIG. 13 requires that valid farming operation candidates be used to feature engineer the operation candidates into activities in step 1330. In order to identify valid candidates, server 110 may divide or split all farming operation candidates into two groups, namely isolated candidates and intersecting candidates. An isolated candidate may be defined as an operation candidate where the start and end time does not intersect with any other operation, whereas an intersecting operation candidate may be defined as an operation candidate where the start and end time intersects with one or more candidates.

Thus, in step 1315, server 110 may identify isolated candidates, which may be further identified as valid candidates in step 1320 for feature engineering into activities in step 1330. However, if, in step 1316, server 110 identifies the operation candidates as intersecting candidates, server 110 may clean and transform the candidates in step 1317, breaking down the intersecting candidates into isolated candidates, so that they may be identified as valid candidates in step 1320 for feature engineering into activities in step 1330.

In step 1330, the disclosed system may feature engineer valid farming operation candidates into activities. As non-limiting examples, each of the operation candidates may be identified as farming, stationary, or missing activities. Farming activities may include any activity that occurs within a field. Farming activities may also include activities which are not “stationary” activities or “missing” activities according to the following definitions. Stationary activities may include any series of heartbeats where the distance between the heartbeats is less than a specified distance (e.g., less than 20 feet), and missing activities may include any activities or series of activities identified by consecutive heartbeats having a time difference of more than 5 minutes. Server 110 may further identify start times, end times, stationary activities, etc. for any farming, stationary, or missing activities.

In step 1340, server 110 may validate or “clean” activities. As non-limiting examples, cleaning and validation activities may include trimming activities and validating activities. Trimming activities may include, as non-limiting examples: removing idle activities (i.e., missing or stationary, as described above) at the start and end of each identified candidate operation and/or activity; and/or removing activities with a duration of less than 1 minute. Validation of activities may include removing candidates with little or no farming activity (e.g., less than X hours/minutes of farming) or removing candidates with a duration less than a specific time frame (e.g., 5 minutes, <X hours/minutes time duration).

In step 1350, server 110 may perform post-processing, including adding travel activities, or adjusting a travelled distance per activity according to a speed decision tree. Specifically, server 110 may add travel activities as part of post-processing, and/or may adjust travel distance per activity given the one or more speed decision tree rules. These rules may further include segmenting based on the speed of the tractor at the time, and whether it was paired to an implement or whether the device was paired to a tractor when it was doing transport, when it was stationary in the field, when it was actually farming, etc. As non-limiting examples, travel distance may be adjusted per activity given the following rules: the speed limit of non-trucking equipment is 20 mph; the speed limit of trucking equipment is 100 mph.

In step 1360, server 110 may create and store one or more farming operations within data storage 130. These operations may include any operation candidates remaining after completing operation validation and/or activity validation described above. For each of the created farming operations, server 110 may transmit the farming operation data to one or more output target hardware or software explicitly targeted to receive system output. As non-limiting examples, these targets may include a GUI for display on a client hardware computing device, the disclosed farming operation generation and recordkeeping system, and/or one or more internal monitoring tools (e.g., bots) used to keep the disclosed system and data accurate and reliable.

In some embodiments, a Machine Learning (ML) classification algorithms may be used to identify operations. Such ML classification algorithms may include sub components configured to classify an aggregation of data. As a non-limiting example, one or more of these subcomponents may classify the aggregation of data as a turn or any other type of domain specific pattern.

The data or features used for identification of events or operations may be arbitrary permutations of any of the data described herein, which in turn may be created by the ML pipeline. These arbitrary permutations may be unknown explicitly or implicitly to the administrator of the disclosed system in the case of a neural network performing a logistic regression and/or the disclosed classification.

The system itself may dynamically parameterize the thresholds and decision making variables disclosed herein as it operates as part of the ML pipeline.

Using the data association with each of the identified and stored farming operations, server 110 may further analyze the farming operation data, as well as third party data (e.g., by executing a remote procedure call to an application programming interface, or API) to generate a plurality of business related context data. Specifically, this business related context data may include: the start and end times of the operation; the equipment, one or more management zones (e.g., farms, fields), and the personnel associated with the operation (e.g., equipment operators); and/or the feature segmentation generated from the feature engineering described above. As non-limiting examples, this feature segmentation may include farming, wherein the assets are actively operating, stationary, where assets are not moving during operation downtime, and/or traveling to or from and/or interrupting machine transport. Feature segmentation may further include start/stop data, duration data, and/or distance of each categorization (farming, stationary, travel)

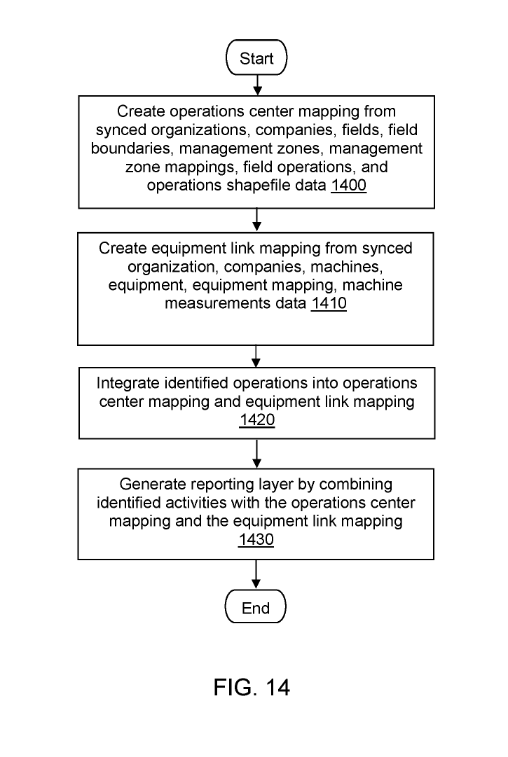

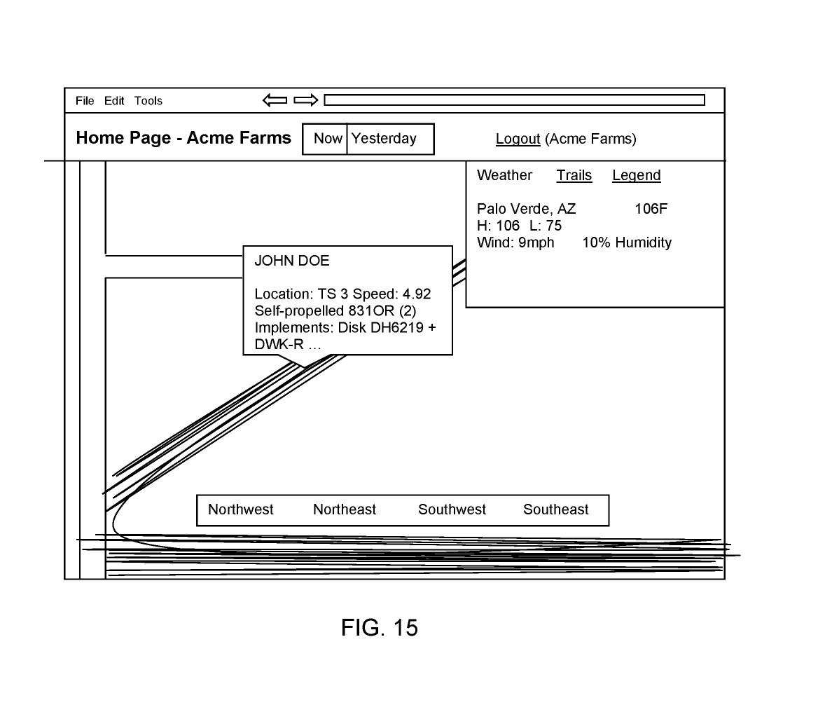

Turning now to FIG. 14, server 110 may create, analyze, store, and/or report the farming operation data and/or the business related context data referred to above. Specifically, the farming operations data may be combined with operations center mappings and/or equipment link mappings to generate a reporting layer, which may generate the reports described herein and demonstrated in FIGS. 15-20.

In step 1400, the disclosed system may synchronize farming operation data associated with organizations, companies, fields, field boundaries, management zones, management zone mappings, field operations, and/or operations shapefile(s) data. This synchronized data may be used to create or otherwise generate an operations center mapping.

In step 1410, the disclosed system may synchronize farming operation and/or third party data associated with organizations, companies, machines, equipment, equipment mappings, and/or machine measurements. This synchronized data may be used to create an equipment link mapping.

In step 1420, the disclosed system may integrate the data from the farming operations identified within the processes disclosed in FIGS. 10-14 into the operations center mapping and/or equipment link mapping generated in steps 1400 and 1410. In step 1430, the disclosed system may generate the reporting layer by combining the identified activities with the operations center mapping, the equipment layer mapping, and the integrated operations.

Turning now to FIG. 15, server 110 may work in conjunction with the reporting layer and the client hardware computing device(s) to generate and display one or more reports of the current farming operations associated with a specific farming organization. These reports may be filtered and searched as is known in the art; thus, farming operations may be searched by equipment, operators, time ranges, farming activities (e.g., spraying, planting), etc.

FIG. 15 demonstrates a non-limiting example GUI, possibly representing a home page presented to a user when they log into the system. In some embodiments, this page may be presented after authenticating to the system via a username and password, for example. The authentication may identify, within a profile, a farming organization associated with the user, and select and display the associated farming operation data stored in data storage 130, or in conjunction with a third party API.

This GUI may display a real time live geospatial view of the operations taking place across the farming organization, which may include farming operations over a great distance. Thus, the GUI may allow the user to zoom in to focus on any number of farming operations and/or fields, which may be identified according to the management zone data stored in data storage 130 and associated with the identified organization.

Without data entry or analysis on the part of the user, server 110 may infer and generate and display business intelligence data from the stored farming operation and third party data, which the farming organization may use to manage farming activities. As a non-limiting example, each of the farming organization's equipment and implements may include an LBTE beacon transmitting the equipment and/or implement's current geographic presence. Server 110 may monitor the attached devices (possibly in conjunction with pairing algorithms running on apps associated with an operator's mobile device, as described above) in order to determine a location from a geospatial service. Server 110 may then compare this location with farming data stored in data storage 130 to identify one or more key location boundaries for the geospatial management zones (e.g., a field) on a farm. As described below, this may also be used to execute a remote procedure call to an API to determine the weather for that location/field, described in more detail below.

As seen in FIG. 15, the GUI may include means to view each piece of equipment associated with a beacon, whether in use or currently not in use. The GUI may further identify the operator and the user's current activity/task, and show the operator/equipment's current position as seen in FIG. 15, which may be updated in real time to reflect current location. As seen in FIG. 15, the GUI may also include the data being transmitted from the beacon, used to identify the equipment, operator, and/or location.

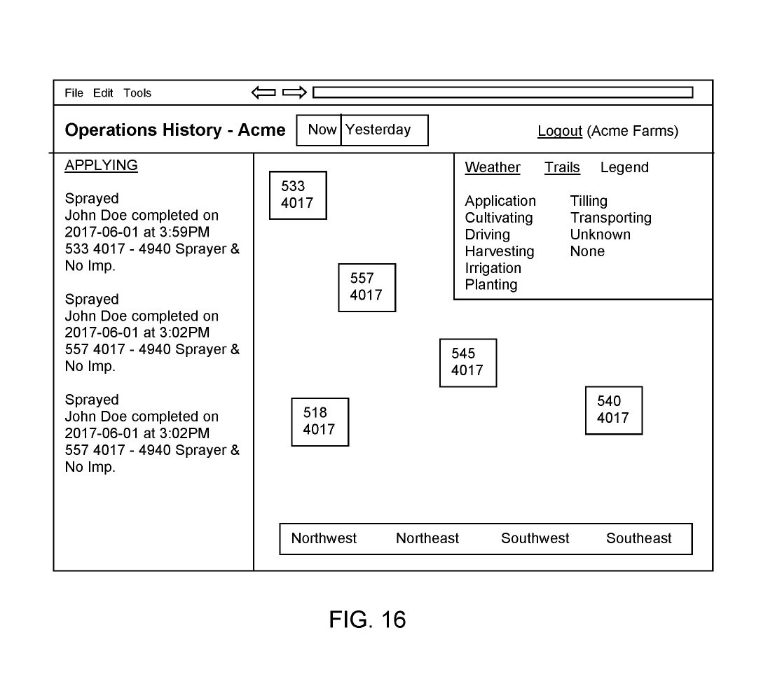

Turning now to FIG. 16, server 110 may generate and display one or more reports of a history of farming operations stored in data storage 139 in association with the farming organization. Using this data, the farming organization may review the collected data to accurately identify inefficiencies within the operations, as well as any outliers in the farming operations. Using the provided legend (possibly color coded, though not demonstrated in FIG. 16), the farming organization may quickly identify types of farming operations which have recently been completed (e.g., application, tilling, cultivating, transporting, driving, harvesting, irrigation, planting, spraying, spreading, unknown, etc.), as well as equipment used, who operated the equipment, what field they were in, etc.

The GUI may further display an activity log, seen on the left side of FIG. 16, representing an example of output, which may be a product of the algorithms and system described above, which created the operations and generated the features. In this example, any stored farming operation activity associated with the selected field may be displayed.

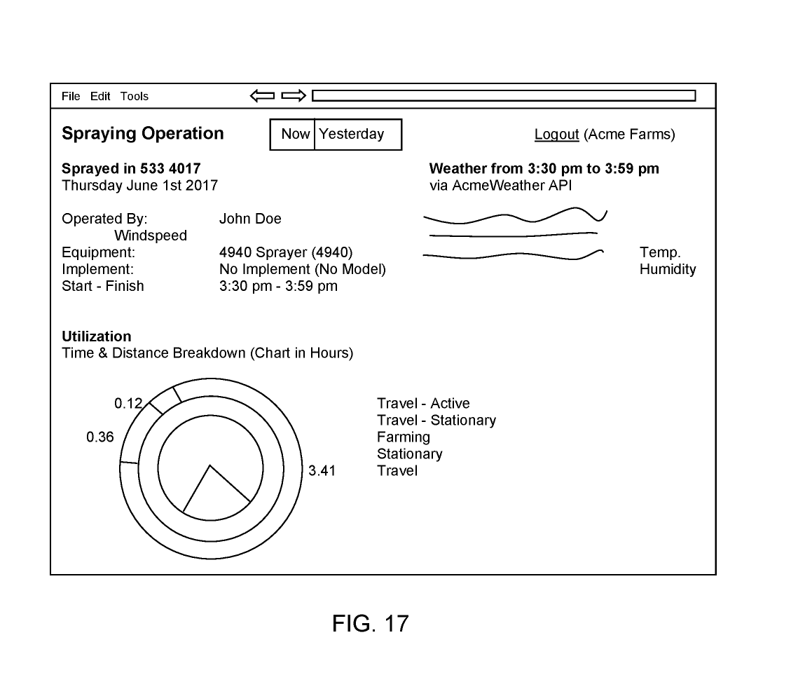

A user may select any of the farming operations displayed in FIG. 16, and on selection, server 110 may generate a GUI such as the non-limiting example GUI seen in FIG. 17. This GUI may expand the feature engineering data available on the first screen, and may reflect the data within the records for the selected farming operations.

In FIG. 17, the data generated is the result of the feature engineering described above. As non-limiting examples, this utilization data may include: time spent traveling to a field (which may be useful for logistics issues), time spent farming in the field, stationary or “downtime” in the field, travel time, etc. These features may allow the farming organization to identify the causes of mistakes, slowing in productivity, downtime, etc. By eliminating such inefficiencies, the farming organization may be more productive, especially in limited opportunity windows such as those described above. If such inefficiencies are not successfully identified and eliminated, the farming organization could lose hundreds of thousands of dollars in opportunity costs.

In addition to utilizing the stored farming operation data records to report farming operation information, the disclosed system may also use the aggregated contextual data in these records in conjunction with third party data sources to generate additional depth to the aggregated data. The disclosed system may outreach to third party software, thereby mapping and data mining additional third party data, which may then be mapped, and/or fetched in meaningful ways (e.g., via third party APIs) to expand the contextual data available to the farming organization.

Turning now to the right side of FIG. 17, server 110 may have executed a remote procedure call to an API for a weather service. This data may be useful to the farming operation, as it may affect planting, spraying, harvesting, etc. Using a mapping of the meaningful features and/or context data engineered above (e.g., time of the activity), as well as the geospatial location data (e.g., the identified field), server 110 may generate a GUI displaying weather observations from a weather station nearest in proximity to the identified field.

For example, in FIG. 17, the wind speed may be between 10 and 15 miles per hour, which may cause a spraying operation to be ineffective, and affect nearby growers or workers. Temperature and humidity may have less impact, but may still be valuable information.

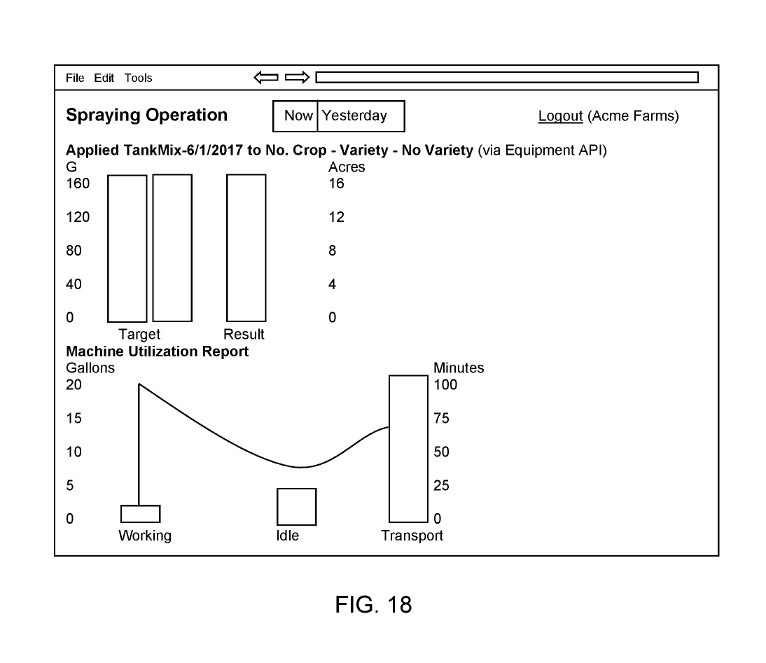

In another example seen in FIG. 18, the third party data may be coming directly from the equipment, which may log running information during a particular time frame. As non-limiting examples, the equipment may include sensors that transmit and upload data related to the usage of the equipment to a database accessible via an API operated by the manufacturer.

In FIG. 18, the equipment may determine the gallons of a tank mix flowing through the equipment accurate to a tenth of a gallon for a chemical that was applied to a crop (e.g., sprayed 1300 gallons). Server 110 may then map the incoming data to the data stored for the farming operation. Additional sensors may transmit data related to fuel use, engine work load/use, derived machine-state (e.g., idling, how the equipment performed, how much fuel was consumed during different kinds of engine states) etc. Server 110 may further map the context data to the operation type, allowing the user to determine whether the received metrics are meaningful or not. For example, this mapping may determine that during spraying, the operator burned 3 gallons of fuel and used it for 26 minutes, while requiring 30 minutes to travel to the field.

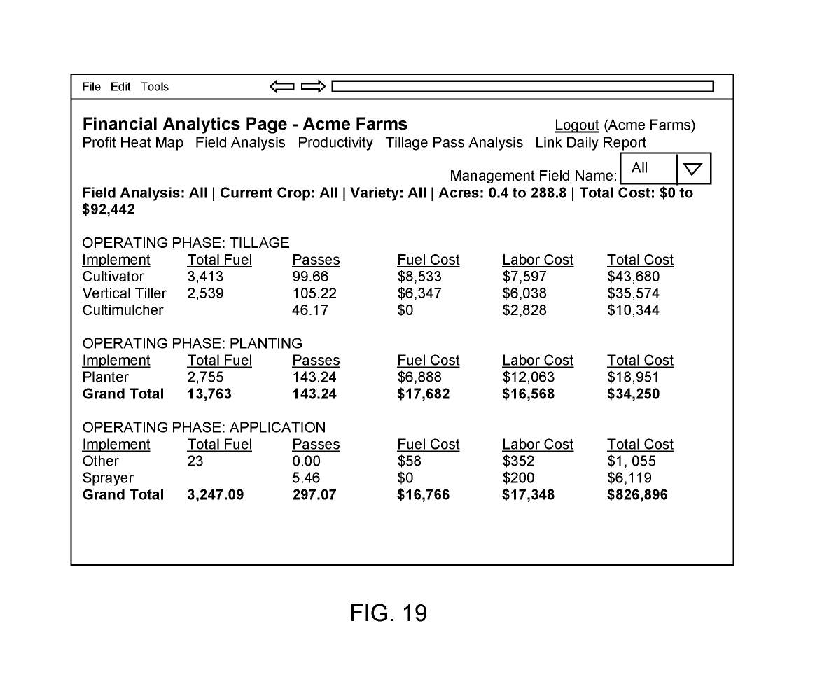

FIG. 19 demonstrates an analytics portion of the disclosed system. By combining cost data with the other types of contextual data described above (e.g., cost per tank mix, for the application, etc. in the example above), server 110 is able to produce the vast majority of a managerial income statement down to the field level, including automatically allocating things like labor, equipment, fuel, product, seed, and/or revenue expenses, as a non-limiting example, for the farming organization. However, this data may be useful to larger farming organizations, as it quickly summarizes a broad range of analytics for farming organizations recording and producing thousands of farming operations.

The analysis for these analytics may also include a mapping of costs based on the data produced in order to identify outliers in geo costs, including products such as chemicals, seed equipment, fuel, labor, etc. The GUI may include drill down capabilities to access a number of reporting capabilities, including, for example, field analysis, income statement, managerial income statement, etc.

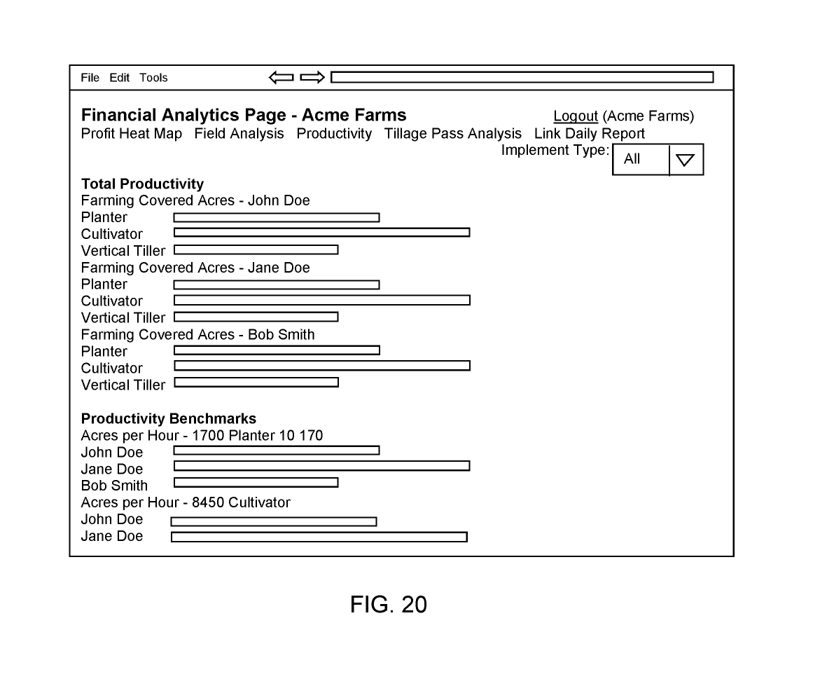

Turning now to FIG. 20, server 110 may further generate and display productivity benchmarks to be completed, juxtaposed against the equipment, operators, types of operations etc. As non-limiting examples, this may include not only a time series for the farming organization to budget their capacity to operate against a given operation window, but it allows them to highlight which equipment may not be performing (e.g., operators are rushing, rather than doing a quality job on something like planting), or if any operators need training on a subset of machinery.

The benchmarks may include productivity benchmarking for a team, so that based on times and features, server 110 may map how many acres are completed per hour per operator, thereby identifying the most efficient operators, allowing the farming organization to forecast and plan accordingly. For example, if the farming organization needed all of the planting done within a two week optimum window, they would be able to determine how many acres they can complete per hour, and which of the operators will be able to complete that task according to average speeds, outliers, etc.

In addition to the GUIs shown in FIGS. 10-15, server 110 may automatically generate an email report to be sent to the farming organization or individuals within it. Users may select to receive such emails at regular intervals (e.g., daily, weekly, etc.). These email reports may include any combination of the data above, such as productivity, weather forecasts, types of operations completed by operators, etc. This system may be automated, selecting the data associated with the organization, which is then sent via a mailing list, as a non-limiting example.

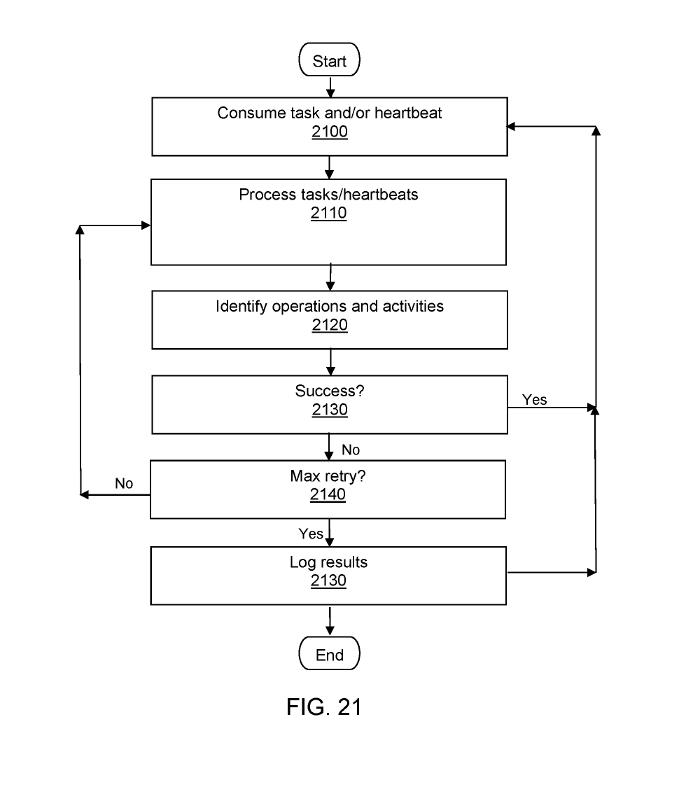

Turning now to FIG. 21, because the disclosed system is automated without user input, relying on the sensor/beacon data to generate the operation data, the system may require one or more internal monitoring tools, as previously referenced, to insure stability and consistency of data analytics. FIG. 21, therefore, is a flow diagram representing a worker life cycle in which the disclosed system monitors system health.

In step 2100, server 110 may consume one or more tasks generated and stored from received device(s) and day data from heartbeats, as described above in association with FIG. 12. In step 2110, server 110 processes the tasks and/or heartbeats. In step 2120, server 110 identifies operations and activities, as described in detail in association with FIG. 13. In step 2130, the system may determine whether the operations and/or activities were successfully identified. If the system successfully identifies the operations and/or activities, the system may then return to step 2100 to consume the next task and/or heartbeat data. However, if the system determines that the operations and/or activities were not successfully identified, the system may further define a threshold of the maximum numbers to retry identifying operations and activities. If the system determines in step 2130 that the operations and activities were not successfully identified, and if the system further determines that the threshold is not reached, the system may return to step 2110, and repeat steps 2110-2140 until the threshold number of maximum attempts is met. If the maximum number of attempts has reached the threshold, the system may then log the results, and return to step 2100, consuming the next task and/or heartbeat.

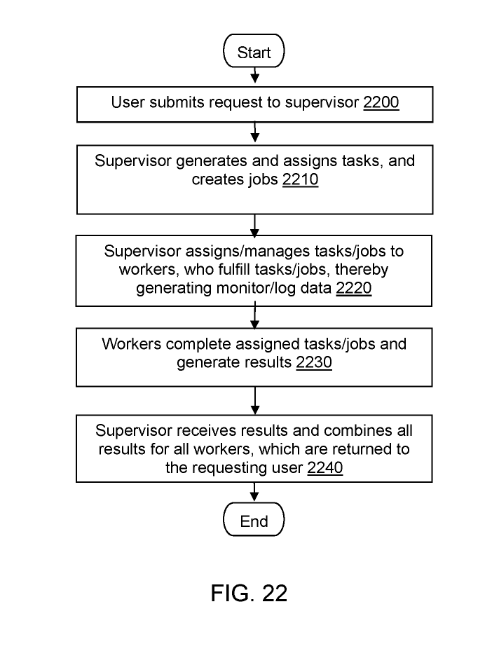

Turning now to FIG. 22, the disclosed system may utilize the processes disclosed above to respond to a user's request for farming operations and/or other reporting data. In step 2200, the user may submit the request to a supervisor system running within the disclosed system. In step 2210, the supervisor may receive the request, and may generate and create and/or assign one or more tasks and/or jobs to one or more workers. In step 2220, the supervisor may assign the tasks/jobs to one or more workers. Each of the workers may fulfill the assigned task/job, and the supervisor may manage the assignment of the task, as well as the management of the task as it is being fulfilled. The supervisor may generate data to be monitored and/or logged as each task is assigned and/or managed. Likewise, the worker may generate data to be monitored and/or logged as each task is fulfilled. In step 2230, each worker may complete the assigned task/job and generate the results requested in association with the task/job. In step 2240, the supervisor may receive the results from each of the workers for each of the tasks/jobs, and combine all results. The combination of results may then be returned to the requesting user.

The disclosed system may include an artificial intelligence (AI) learning iterative process. This AI learning iterative process may generate a database for each device in the disclosed system. The disclosed system may layout the GPS data points into an interactive gamified map, and display the collected GPS data points to a user. The user may then select an individual GPS data point, and flag the selected individual data point based on context. Specifically, the user may flag the start of an operation and the end of an operation. The disclosed system may then populate the operation with collected data, including an operator ID, equipment ID, management zone ID, an amount of time spent, a distance travelled, an operation type and/or purpose for the operation, as non-limiting examples. The user may then complete any missing data and/or override any incorrect data.

The disclosed system may then compute a score, determining the score in order to evaluate the operation detection accuracy while taking all variables into consideration. Specifically, the system may process the score according to time boundaries with a plus or minus 10 minute tolerance. Processing the score may include: true positives, wherein the algorithm found an operation existing in the dataset; false positives, wherein the algorithm found an operation which didn't exists in the dataset; false negatives, wherein the algorithm missed an operation which exists in the dataset; and a true negative, wherein no operation is found, and there's no operation in the dataset. For each true positive, the disclosed system may compute the score according to “inner” data including equipment IDs, management zone IDs, and operator IDs, as non-limiting examples. The computation may conclude by comparing with a previous score.

The disclosed system may use the computed score in a development environment, wherein the computed score is used to quickly identify any introduced bugs and/or regressions, or may be used in a production environment, wherein the computed score is used to adjust thresholds (e.g., minimum number of heartbeats, delays/timeouts, etc.). Once the bugs are fixed and/or threshold adjusted, the system may iterate by re-running the operation detection algorithm and reprocessing the score.

Other embodiments and uses of the above invention will be apparent to those having ordinary skill in the art upon consideration of the specification and practice of the invention disclosed herein. The specification and examples given should be considered exemplary only, and it is contemplated that the appended claims will cover any other such embodiments or modifications as fall within the true scope of the invention.

The Abstract accompanying this specification is provided to enable the United States Patent and Trademark Office and the public generally to determine quickly from a cursory inspection the nature and gist of the technical disclosure and in no way intended for defining, determining, or limiting the present invention or any of its embodiments.

The invention claimed is:

1. A system comprising a server hardware computing device coupled to a network and comprising at least one processor executing specific computer-executable instructions within a memory that, when executed, cause the system to:
receive, from a sensor beacon, a plurality of location and bearing data;
query a database coupled to the network to identify, in association with the sensor beacon:
a geospatial boundary associated with an organization, and
an equipment asset;
identify, without user input:
an operation comprising a cluster of the plurality of location and bearing data received at regular predefined intervals within the geospatial boundary during a time span,
at least one working or stationary activity according to a physical distance within the location and bearing data during the time span;
automatically generate a graphical user interface (GUI) displaying a report including the operation and the at least one working or stationary activity; and
transmit the GUI to a client hardware computing device for display.

2. The system of claim 1, wherein the sensor beacon is physically attached to the equipment asset.

3. The system of claim 2, wherein the sensor beacon is coupled to a client software operated by an operator of the equipment asset.

4. The system of claim 1, wherein the cluster of the plurality of location and bearing data is identified by:
selecting, from the database, the at least one geospatial boundary associated with the organization; and
automatically identifying the cluster of the plurality of location and bearing data as a grouping associated with, and existing within,
the geospatial boundary.

5. The system of claim 4, wherein the grouping comprises an operation candidate.

6. The system of claim 5, wherein the operation candidate is validated according to:
an amount of the plurality of location and bearing data received; or
an amount of a plurality of turn events received, each of the plurality of turn events comprising a change in a bearing data within the plurality of location and bearing data greater than a defined threshold.

7. The system of claim 1, wherein the report includes:
a graphical representation of the geospatial boundary;
a real time location of the equipment asset within the geospatial boundary; and
an operator identification of the operator operating the equipment asset.

8. The system of claim 1, wherein the report includes a history of operations within the geospatial boundary.

9. The system of claim 1, wherein the report includes a combination of the operation and the at least one working or stationary activity with a plurality of data generated by the equipment asset.

10. The system of claim 1, wherein the report includes a plurality of financial analytics for the organization.

11. A method comprising the steps of:
receiving, by a server hardware computing device coupled to a network and comprising at least one processor executing specific computer-executable instructions within a memory, from a sensor beacon, a plurality of location and bearing data;
querying a database coupled to the network to identify, in association with the sensor beacon:
a geospatial boundary associated with an organization, and
an equipment asset;
identifying, without user input:
an operation comprising a cluster of the plurality of location and bearing data received at regular predefined intervals within the geospatial boundary during a time span,
at least one working or stationary activity according to a physical distance within the location and bearing data during the time span;
automatically generating a graphical user interface (GUI) displaying a report including the operation and the at least one working or stationary activity; and
transmitting the GUI to a client hardware computing device for display.

12. The method of claim 11, wherein the sensor beacon is physically attached to the equipment asset.

13. The method of claim 12, wherein the sensor beacon is coupled to a client software operated by an operator of the equipment asset.

14. The method of claim 11, wherein the cluster of the plurality of location and bearing data is identified by:
selecting, from the database, the at least one geospatial boundary associated with the organization; and
automatically identifying the cluster of the plurality of location and bearing data as a grouping associated with, and existing within,
the geospatial boundary.

15. The method of claim 14, wherein the grouping comprises an operation candidate.

16. The method of claim 15, wherein the operation candidate is validated according to:
an amount of the plurality of location and bearing data received; or
an amount of a plurality of turn events received, each of the plurality of turn events comprising a change in a bearing data within the plurality of location and bearing data greater than a defined threshold.

17. The method of claim 11, wherein the report includes:
a graphical representation of the geospatial boundary;
a real time location of the equipment asset within the geospatial boundary; and
an operator identification of the operator operating the equipment asset.

18. The method of claim 11, wherein the report includes a history of operations within the geospatial boundary.

19. The method of claim 11, wherein the report includes a combination of the operation and the at least one working or stationary activity with a plurality of data generated by the equipment asset.

20. The method of claim 11, wherein the report includes a plurality of financial analytics for the organization.
